(19) United States
(12) Patent Application Publication
(10) Pub. No.: US 2026/0301276 A1
(43) Pub. Date: Oct. 1, 2026

(54) MEDICAL IMAGE PROCESSING METHOD, NEURAL NETWORK MODEL TRAINING METHOD AND MEDICAL IMAGING SYSTEM

(71) Applicant: GE Precision Healthcare LLC, Waukesha, WI (US)

(72) Inventors: Xiaokun Huang, Beijing (CN); Bingjie Zhao, Beijing (CN); Xueli Wang, Beijing (CN); Ximiao Cao, Beijing (CN); Jiahe Qu, Beijing (CN)

(21) Appl. No.: 19/635,385

(22) Filed: Mar. 31, 2026

(30) Foreign Application Priority Data
Mar. 31, 2025 (CN) 202510399686.4

(51) Int. Cl. G06T 12/20; G06T 3/4046

(52) U.S. Cl. CPC G06T 12/20; G06T 3/4046; G06T 2210/41; G06T 2211/421; G06T 2211/441

(57) ABSTRACT

The present disclosure relates to a medical image processing method, a neural network model training method, and a medical imaging system. The method includes: using a first neural network model to generate, based on first projection data, second projection data, where the second projection data has a higher resolution than the first projection data, and the first neural network model is trained on high-resolution projection data and low-resolution projection data generated by a virtual medical imaging system; reconstructing the second projection data to generate a first reconstructed image; and using a second neural network model to generate, based on the first reconstructed image, a second reconstructed image, where the second reconstructed image has a higher resolution than the first reconstructed image.

### CROSS-REFERENCE TO RELATED APPLICATIONS

This application claims priority to Chinese Application No. 202510399686.4, filed on Mar. 31, 2025, the disclosure of which is incorporated herein by reference in its entirety.

### TECHNICAL FIELD

The present disclosure relates to the field of medical imaging, and in particular, to a medical image processing method, a neural network model training method, and a medical imaging system.

### BACKGROUND

Medical imaging techniques allow non-invasive acquisition of images of internal structure or features of a subject (such as a patient). A digital X-ray imaging system produces digital data that can be reconstructed into radiographic images, such as in computed tomography (CT) or digital breast tomosynthesis (DBT) imaging processes. In a digital X-ray imaging system, radiation from a source is directed toward the subject. A portion of the radiation passes through the subject and impinges on a detector. The detector includes an array of discrete picture elements or detector pixels, and performs processing based on the amount or intensity of radiation impinging on each pixel area to obtain projection data. Complete projection data can be reconstructed into accurate slice images by a computer for diagnosis. The reconstructed images are used to identify and/or examine internal structures and organs within the patient. The higher the image resolution, the clearer the internal structures and organs can be distinguished, thereby obtaining more accurate diagnostic results.

### SUMMARY OF THE INVENTION

It should be understood that both the foregoing general description and the following detailed description of the present disclosure are exemplary and illustrative, and are intended to provide further explanation of the present disclosure as set forth in the claims.

According to a first aspect of the present disclosure, provided is a method for medical image processing, comprising: using a first neural network model to generate, based on first projection data, second projection data, wherein the second projection data has a higher resolution than the first projection data, and the first neural network model is trained on high-resolution projection data and low-resolution projection data generated by a virtual medical imaging system; reconstructing the second projection data to generate a first reconstructed image; and using a second neural network model to generate, based on the first reconstructed image, a second reconstructed image, wherein the second reconstructed image has a higher resolution than the first reconstructed image.

Optionally, the first projection data comprises: raw projection data, wherein the raw projection data is three-dimensional projection data acquired by scanning a subject under examination by a detector of the medical imaging system and the raw projection data comprises three dimensions: a row direction, a channel direction, and a viewing angle direction, the row direction indicates a direction of the detector in which the subject under examination moves toward or out of the medical imaging system, the channel direction indicates an extension direction of the detector arranged to partially surround the subject under examination, which is perpendicular to the row direction, and the viewing angle direction indicates an angle at which the detector acquires the raw projection data at each of different positions around the subject under examination.

Optionally, the first projection data further comprises: filtered projection data, wherein the filtered projection data is obtained by filtering the raw projection data by a kernel function.

Optionally, the kernel function comprises one or more of the following: a standard kernel function, a bone kernel function, a bone plus kernel function, and an edge kernel function.

Optionally, the first neural network model is configured to perform up-sampling in the channel direction on two-dimensional projection data of the first projection data in the viewing angle direction, so that the second projection data has a higher resolution than the first projection data in a row-channel plane.

Optionally, the reconstructing the second projection data comprises: adjusting a reconstruction parameter according to a resolution increase multiple of the second projection data compared with the first projection data.

Optionally, the adjusting a reconstruction parameter according to a resolution increase multiple of the second projection data compared with the first projection data comprises: scaling the reconstruction parameter in the channel direction according to the resolution increase multiple; re-determining a position of a central detector cell; and adjusting a cut-off frequency and a filter window width of the kernel function in a reconstruction process.

Optionally, the reconstruction parameter in the channel direction comprises: the number of channel detector cells, sizes of the channel detector cells, and angles of the channel detector cells.

Optionally, the first neural network model uses a residual channel attention network (RCAN).

Optionally, the high-resolution projection data and the low-resolution projection data are generated through the following steps: constructing the virtual medical imaging system by using simulation software, the virtual medical imaging system comprising a low-resolution medical imaging system and a high-resolution medical imaging system; performing a first simulated scan on a simulated phantom of a subject under scanning by using the low-resolution medical imaging system to obtain the low-resolution projection data; performing a second simulated scan on the simulated phantom of the subject under scanning by using the high-resolution medical imaging system to obtain the high-resolution projection data; and associating the low-resolution projection data of the subject under scanning with the high-resolution projection data of the subject under scanning to generate a low-resolution and high-resolution projection data pair of the subject under scanning.

Optionally, the second neural network model is configured to perform up-sampling in the row direction on the first reconstructed image, so that the second reconstructed image has a higher resolution than the first reconstructed image in the row direction.

According to a second aspect of the present disclosure, provided is a method for training a neural network model, comprising: acquiring a training data set, the training data set comprising a training thick reconstructed image and a training thin reconstructed image, wherein the training thick reconstructed image and the training thin reconstructed image are obtained by splitting a training raw reconstructed image, the training thin reconstructed image has a higher resolution than the training thick reconstructed image, and the training thin reconstructed image is used as a ground truth of an output of the neural network model; and training the neural network model in a supervised manner based on the training data set.

Optionally, the training raw reconstructed image is a reconstructed image obtained by performing reconstruction based on three-dimensional projection data, the three-dimensional projection data is acquired by scanning a subject under examination by a detector of a medical imaging system and the three-dimensional projection data comprises three dimensions: a row direction, a channel direction, and a viewing angle direction, the row direction indicates a direction of the detector in which the subject under examination moves toward or out of the medical imaging system, the channel direction indicates an extension direction of the detector arranged to partially surround the subject under examination, which is perpendicular to the row direction, and the viewing angle direction indicates an angle at which the detector acquires the three-dimensional projection data at each of different positions around the subject under examination.

Optionally, the training thick reconstructed image and training thin reconstructed image are obtained through the following steps: splitting the training raw reconstructed image into a first subset and a second subset alternately at equal intervals in the row direction; and averaging each two adjacent images in the first subset to obtain a plurality of averaged images, wherein the plurality of averaged images are combined to be used as the training thick reconstructed image, images in the second subset are combined to be used as the training thin reconstructed image, and the training thin reconstructed image has a higher resolution than the training thick reconstructed image in the row direction.

Optionally, the training the neural network model in a supervised manner based on the training data set comprises: using the neural network model to generate, based on the training thick reconstructed image, a predicted result of an enhanced reconstructed image having a higher resolution than the training thick reconstructed image; calculating a loss function between the predicted result and the ground truth; and updating parameters of the neural network model based on the loss function to obtain a trained neural network model.

Optionally, a weight of the loss function in the row direction is greater than weights of the loss function in the channel direction and the viewing angle direction.

According to a third aspect of the present disclosure, provided is a medical imaging system, comprising: a scanning device, configured to acquire projection data of a subject under examination; and a processor, configured to perform the method according to any one of the foregoing aspects.

According to a fourth aspect of the present disclosure, provided is a non-transient computer-readable medium, having instructions stored thereon, wherein the instructions are executable by a processor to implement the method according to any one of the foregoing items.

### BRIEF DESCRIPTION OF THE DRAWINGS

The present disclosure can be better understood by means of the description of the exemplary embodiments of the present disclosure in conjunction with the drawings, in which:

FIG. 1 shows a schematic diagram of an exemplary CT system configured for CT imaging;

FIG. 2 shows an exemplary imaging system similar to the CT system in FIG. 1;

FIG. 3 shows a schematic diagram of a CT system during patient examination;

FIG. 4 shows a flowchart of a medical image processing method according to an exemplary embodiment of the present disclosure;

FIG. 5 shows a schematic diagram of a medical image processing process according to an exemplary embodiment of the present disclosure;

FIG. 6 shows a schematic diagram of raw projection data according to an exemplary embodiment of the present disclosure;

FIG. 7 shows a schematic diagram of frequency response curves of different kernel functions according to an exemplary embodiment of the present disclosure;

FIG. 8 shows a schematic diagram of first projection data according to an exemplary embodiment of the present disclosure;

FIG. 9 shows a schematic diagram of a first neural network model according to an exemplary embodiment of the present disclosure;

FIG. 10 shows a flowchart of a method for generating low-resolution projection data and high-resolution projection data according to an exemplary embodiment of the present disclosure;

FIG. 11 shows a schematic diagram of a low-resolution medical imaging system setting and a high-resolution medical imaging system setting and imaging thereof according to an exemplary embodiment of the present disclosure;

FIG. 12 shows a flowchart of a method for training a neural network model according to an exemplary embodiment of the present disclosure;

FIG. 13 shows a flowchart of a method for generating a training thick reconstructed image and a training thin reconstructed image according to an exemplary embodiment of the present disclosure;

FIG. 14 shows a schematic diagram of a process for generating a training thick reconstructed image and a training thin reconstructed image according to an exemplary embodiment of the present disclosure;

FIG. 15 shows a schematic diagram of a training thick reconstructed image and a training thin reconstructed image according to an exemplary embodiment of the present disclosure;

FIG. 16A to FIG. 16D show diagrams of comparison between reconstructed images generated directly according to raw projection data and reconstructed images generated according to raw projection data by using the method of the present disclosure; and

FIG. 17 shows an exemplary block diagram of a computing device according to an exemplary embodiment of the present disclosure.

In the accompanying drawings, similar components and/or features may have the same numerical reference signs. Further, components of the same type may be distinguished by letters following the reference sign, and the letters may be used for distinguishing between similar components and/or features. If only a first numerical reference sign is used in the specification, the description is applicable to any similar component and/or feature having the same first numerical reference sign irrespective of the subscript of the letter.

### DETAILED DESCRIPTION

Specific embodiments of the present disclosure will be described below, but it should be noted that in the specific description of these embodiments, for the sake of brevity of description, it is impossible to describe all features of the actual embodiments of the present disclosure in detail in this description. It should be understood that in the actual implementation process of any implementation, just as in the process of any one engineering project or design project, a variety of specific decisions are often made to achieve specific goals of the developer and to meet system-related or business-related constraints, which may also vary from one implementation to another. Furthermore, it should also be understood that although efforts made in such development processes may be complex and tedious, for those of ordinary skill in the art related to the content of the present disclosure, some design, manufacture, or production changes made on the basis of the technical content disclosed in the present disclosure are only common technical means, and should not be construed as the content of the present disclosure being insufficient.

References in the specification to “some embodiments,” “embodiment,” “exemplary embodiment,” and so on indicate that the embodiment described may include a specific feature, structure, or characteristic, but the specific feature, structure, or characteristic is not necessarily included in every embodiment. Besides, such phrases do not necessarily refer to the same embodiment. Further, when a specific feature, structure, or characteristic is described in connection with an embodiment, it is believed that affecting such feature, structure, or characteristic in connection with other embodiments (whether or not explicitly described) is within the knowledge of those skilled in the art.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

Unless otherwise defined, the technical or scientific terms used in the claims and the description should be as they are usually understood by those possessing ordinary skill in the technical field to which they belong. The terms “first,” “second,” and the like used in the description and claims of the patent application of the present disclosure do not denote any order, quantity, or importance, but are merely intended to distinguish between different constituents. The terms “one” or “a/an” and similar terms do not express a limitation of quantity, but rather that at least one is present. The terms “include” or “comprise” and similar words indicate that an element or object preceding the terms “include” or “comprise” encompasses elements or objects and equivalent elements thereof listed after the terms “include” or “comprise”, and do not exclude other elements or objects. The terms “connect,” “couple,” or “link” and similar words are not limited to physical or mechanical connections, and are not limited to direct or indirect connections.

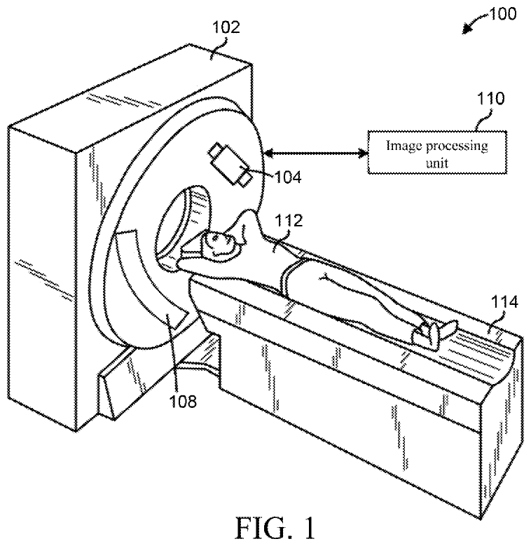

Embodiments of the present disclosure will be described below by way of example with reference to FIG. 1 to FIG. 17. Although a CT system is described by way of example, it should be understood that the techniques of the present disclosure are broadly applicable to various fields of non-destructive examination. The techniques of the present disclosure may also be useful when applied to images acquired by using other imaging modalities, such as X-ray imaging systems, positron emission tomography (PET) imaging systems, single photon emission computed tomography (SPECT) imaging systems, and combinations thereof (e.g., multi-modal imaging systems such as PET/CT, PET/MR, or SPECT/CT imaging systems). Exemplarily, the embodiments of the present disclosure are described below in conjunction with X-ray computed tomography (CT) imaging. Those skilled in the art would appreciate that the embodiments of the present disclosure can also be applied to other medical imaging.

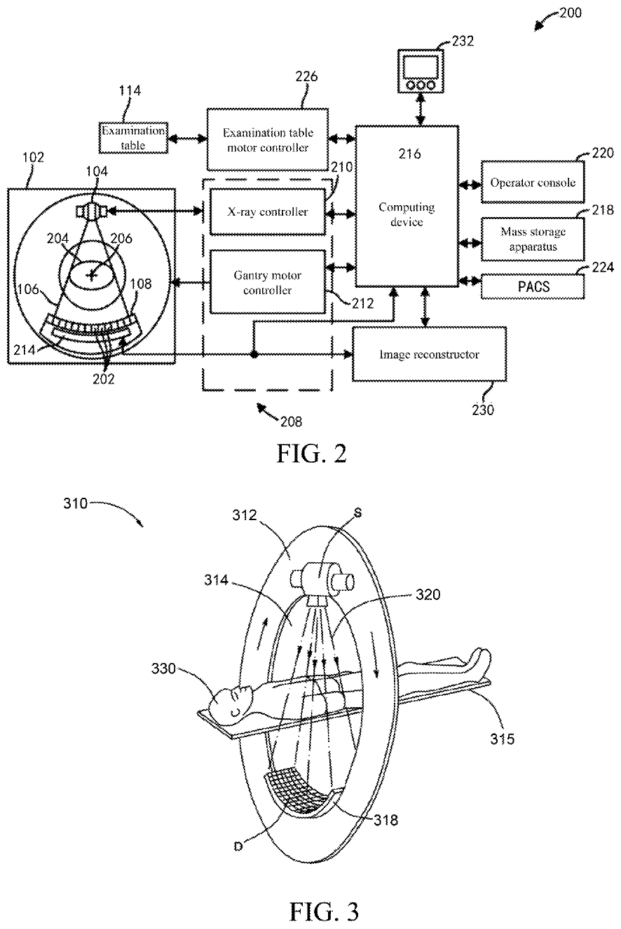

FIG. 1 shows a schematic diagram of an exemplary CT system 100 configured for CT imaging. Specifically, the CT system 100 is configured to image a subject 112 (such as a patient, an inanimate object, or one or more manufactured components) and/or a foreign object (such as a dental implant, a stent, and/or a contrast agent present in the body). In one implementation, the CT system 100 includes a gantry 102, which in turn may further include at least one X-ray source 104. The at least one X-ray source is configured to project an X-ray radiation beam 106 (see FIG. 2) for imaging the subject 112 lying on an examination table 114. Specifically, the X-ray source 104 is configured to project the X-ray radiation beam 106 toward a detector array 108 positioned on the opposite side of the gantry 102. Although FIG. 1 depicts a single X-ray source 104, in certain implementations, a plurality of X-ray sources and detectors may be used to project a plurality of X-ray radiation beams, so as to acquire projection data corresponding to the patient at different energy levels. In some implementations, the X-ray source 104 may achieve dual-energy gemstone spectral imaging (GSI) by means of rapid peak kilovoltage (kVp) switching. In some implementations, the X-ray detectors used are photon counting detectors capable of distinguishing X-ray photons of different energies. In other implementations, dual-energy projections are generated using two sets of X-ray sources and detectors, wherein one set of X-ray sources and detectors is set to low kVp and the other set is set to high kVp. It should therefore be understood that the methods described herein may be implemented using single-energy acquisition techniques and dual-energy acquisition techniques.

In certain implementations, the CT system 100 further includes an image processing unit 110, and the image processing unit is configured to reconstruct images of a target volume of the subject 112 by using iterative or analytical image reconstruction methods. For example, the image processing unit 110 may reconstruct images of a target volume of the patient by using analytical image reconstruction methods such as filtered back projection (FBP). As another example, the image processing unit 110 may use iterative image reconstruction methods (such as advanced statistical iterative reconstruction (ASIR), conjugate gradient (CG), maximum likelihood expectation maximization (MLEM), model-based iterative reconstruction (MBIR), etc.) to reconstruct images of a target volume of the subject 112.

In some CT imaging system configurations, the X-ray source projects a conical X-ray radiation beam, which is collimated to be located within an X-Y-Z plane of a Cartesian coordinate system, and the plane is usually referred to as an “imaging plane”. The X-ray radiation beam passes through an object being imaged, such as a patient or a subject. After being attenuated by the object, the X-ray radiation beam is incident on an array of detector elements. The intensity of the attenuated X-ray radiation beam received at the detector array depends on the attenuation of the X-ray radiation beam by the object. Each detector element of the array produces a separate electrical signal, the separate electrical signal being a measurement of X-ray beam attenuation at the detector position. Attenuation measurements from all detector elements are individually acquired to generate a transmission distribution.

In some CT systems, a gantry is used to rotate, in the imaging plane, the X-ray source and the detector array around the object to be imaged, so that the angle at which the X-ray beam intersects the object continually changes. A set of X-ray radiation attenuation measurement results (e.g., projection data) from the detector array at a gantry angle is referred to as a “view”. A “scan” of the object includes a set of views made at different gantry angles or viewing angles during a single rotation of the X-ray source and detector. It can be contemplated that benefits of the method in this specification derive from a medical imaging modality other than CT. Therefore, as used herein, the term “view” is not limited to the use described above with respect to projection data from one gantry angle. The term “view” is used to mean one data acquisition when there are a plurality of data acquisitions (acquisitions from CT, positron emission tomography (PET), or single photon emission CT (SPECT)) from different angles, and/or any other modality (including a modality to be developed) and combinations thereof in fused implementations.

Projection data is processed to reconstruct images corresponding to two-dimensional slices acquired through the object, or, in some examples in which the projection data includes a plurality of views or scans, to reconstruct images corresponding to three-dimensional images of the object. A method for reconstructing an image from a set of projection data is referred to as a filtered back projection technique in the art. Transmission and emission tomography reconstruction techniques also include statistical iterative methods, such as maximum likelihood expectation maximization (MLEM) and ordered subset expectation reconstruction techniques, as well as iterative reconstruction techniques. The method converts an attenuation measurement from a scan into an integer referred to as a “CT number” or “Hounsfield unit”, which is used to control the brightness of a corresponding pixel on a display device.

To reduce the total scan time, a “helical” scan may be performed. To perform the “helical” scan, the patient is moved when data of a specified number of slices is acquired. Such systems produce a single helix from helical scanning of a conical beam. The helix mapped out by the conical beam produces projection data according to which an image in each specified slice can be reconstructed.

As used herein, the phrase “reconstructed image” refers to an image generated by reconstructing projection data acquired by an imaging system, usually a tomographic image or a tomographic reconstructed image, and the “reconstructed image” not only refers to generating a visible image, but also includes a scheme of generating data for representing an image. Thus, as used herein, the term “image” broadly refers to both a visual image and data representing a visual image. However, many implementations generate (or are configured to generate) at least one visual image.

FIG. 2 shows an exemplary imaging system 200 similar to the CT system 100 in FIG. 1. According to aspects of the present disclosure, the imaging system 200 is configured to image a subject 204 (e.g., the subject 112 of FIG. 1). In one implementation, the imaging system 200 includes the detector array 108 (see FIG. 1). The detector array 108 further includes a plurality of detector elements 202, which together sense the X-ray radiation beam 106 (see FIG. 2) passing through the subject 204 (such as a patient) to acquire corresponding projection data. Therefore, in one implementation, the detector array 108 is fabricated in a multi-row or multi-line configuration including a plurality of rows or lines of units or detector elements 202. In such a configuration (e.g., multi-row or multi-line detector CT or MDCT), another row or a plurality of rows of detector elements 202 are arranged in a parallel configuration to acquire projection data. The configuration may include 4, 8, 16, 32, 64, 128, or 256 rows or lines of detector elements. For example, a 64-row MDCT scanner may have 64 rows or lines of detector elements, while a 256-row MDCT scanner may have 256 rows or lines of detector elements. Therefore, four rotations of a helical scan performed by a 64-row or 64-line MDCT scanner can achieve a detector coverage equal to a single rotation of a scan performed by a 256-row or 256-line MDCT scanner.

In certain implementations, the imaging system 200 is configured to traverse different angular positions around the subject 204 to acquire required projection data. Therefore, the gantry 102 and components mounted thereon can be configured to rotate about a center of rotation 206 to acquire projection data at different energy levels, for example. Alternatively, in implementations in which the projection angle with respect to the subject 204 changes over time, the mounted components may be configured to move along a generally curved line rather than along a segment of a circular arc.

Therefore, when the X-ray source 104 and the detector array 108 rotate, the detector array 108 collects data of the attenuated X-ray beam. The data collected by the detector array 108 is then subjected to pre-processing and calibration to adjust the data so as to represent line integrals of attenuation coefficients of the scanned subject 204. The processed data is generally referred to as a projection.

In some examples, individual detectors or detector elements 202 in the detector array 108 may include photon counting detectors which register interactions of individual photons into one or more energy bins. It should be understood that the method described herein may also be implemented using an energy integration detector.

An acquired projection data set may be used for base material decomposition (BMD). During the BMD, the measured projection is converted to a set of material density projections. The material density projections may be reconstructed to form one pair or a set of material density maps or images (such as bone, soft tissue, and/or contrast agent maps) of each corresponding base material. The density maps or images may then be correlated to form a 3D volumetric image of the base material (e.g., bone, soft tissue, and/or a contrast agent) in the imaging volume.

Once reconstructed, the base material image produced by the imaging system 200 displays the internal features of the subject 204 represented in terms of the densities of two base materials. The density images can be displayed to demonstrate the foregoing features. In a conventional method for diagnosing medical conditions (such as disease states), and more generally for diagnosing medical events, a radiologist or physician considers a hard copy or display of a density image to discern characteristic features of interest. Such features may include a lesion, size, and shape of a particular anatomical structure or organ, and other features should be discernible in the image on the basis of the skill and knowledge of an individual practitioner.

In one implementation, the imaging system 200 includes a control mechanism 208 to control movement of components, such as the rotation of the gantry 102 and the operation of the X-ray source 104. In certain implementations, the control mechanism 208 further includes an X-ray controller 210, configured to provide power and timing signals to the X-ray source 104. Additionally, the control mechanism 208 includes a gantry motor controller 212, configured to control the rotational speed and/or position of the gantry 102 on the basis of imaging requirements.

In certain implementations, the control mechanism 208 further includes a data acquisition system (DAS) 214, configured to sample analog data received from the detector elements 202, and to convert the analog data into digital signals for subsequent processing. The DAS 214 may further be configured to selectively aggregate analog data from a subset of the detector elements 202 into a so-called macro detector, as described further herein. The data sampled and digitized by the DAS 214 is transmitted to a computer or computing device 216. In an example, the computing device 216 stores data in a storage device or mass storage apparatus 218. For example, the storage device 218 may include a hard disk drive, a floppy disk drive, a compact disc-read/write (CD-R/W) drive, a digital versatile disc (DVD) drive, a flash drive, and/or a solid-state storage drive.

Additionally, the computing device 216 provides commands and parameters to one or more of the DAS 214, the X-ray controller 210, and the gantry motor controller 212 to control system operations, such as data acquisition and/or processing. In certain implementations, the computing device 216 controls system operations on the basis of operator input. The computing device 216 receives the operator input by means of an operator console 220 that is operably coupled to the computing device 216, the operator input including, for example, commands and/or scan parameters. The operator console 220 may include a keyboard (not shown) or a touch screen to allow the operator to specify commands and/or scan parameters.

Although FIG. 2 shows one operator console 220, more than one operator console may be coupled to the imaging system 200, and, for example, is used to input or output system parameters, request examination, map data, and/or view images. Moreover, in certain implementations, the imaging system 200 may be coupled to, for example, a plurality of displays, printers, workstations, and/or similar devices located locally or remotely within an institution or hospital or in a completely different position via one or more configurable wired and/or wireless networks (such as the Internet and/or a virtual private network, a wireless telephone network, a wireless local area network, a wired local area network, a wireless wide area network, a wired wide area network, etc.).

In one implementation, for example, the imaging system 200 includes or is coupled to a picture archiving and communication system (PACS) 224. In an exemplary implementation, the PACS 224 is further coupled to a remote system (such as a radiology information system or a hospital information system) and/or coupled to an internal or external network (not shown) to allow an operator at a different position to provide commands and parameters and/or obtain access to image data.

The computing device 216 uses operator-supplied and/or system-defined commands and parameters to operate an examination table motor controller 226, which can in turn control the examination table 114. The examination table may be an electric examination table. Specifically, the examination table motor controller 226 may move the examination table 114 to properly position the subject 204 in the gantry 102, so as to acquire projection data corresponding to a target volume of the subject 204.

As described previously, the DAS 214 samples and digitizes projection data acquired by the detector elements 202. Subsequently, an image reconstructor 230 uses the sampled and digitized X-ray data to perform high-speed reconstruction. Although the image reconstructor 230 is shown as a separate entity in FIG. 2, in certain implementations, the image reconstructor 230 may form a part of the computing device 216. Alternatively, the image reconstructor 230 may not be present in the imaging system 200, and the computing device 216 may instead perform one or more functions of the image reconstructor 230. In addition, the image reconstructor 230 may be located locally or remotely and may be operably connected to the imaging system 200 by using a wired or wireless network. Specifically, in one exemplary embodiment, computing resources in a “cloud” network cluster may be used for the image reconstructor 230.

In one implementation, the image reconstructor 230 stores a reconstructed image in the storage device 218. Alternatively, the image reconstructor 230 may transmit the reconstructed image to the computing device 216 to generate usable patient information for diagnosis and evaluation. In certain implementations, the computing device 216 may transmit the reconstructed image and/or patient information to a display or display device 232, the display or display device being communicatively coupled to the computing device 216 and/or the image reconstructor 230. In some implementations, the reconstructed image may be transmitted from the computing device 216 or the image reconstructor 230 to the storage device 218 for short-term or long-term storage.

In CT imaging, an X-ray intensity attenuation formula can be used to quantitatively describe attenuation of the intensity of X-rays when passing through different tissues. The X-ray intensity attenuation formula can be expressed as: I=I_0 e\hat{ }(−μx), where I is the X-ray intensity of the X-ray after passing through an absorbing medium, I_0 is an initial X-ray intensity, i.e., the intensity before the X-ray passes through any material, u is a ray attenuation coefficient of the medium to the X-ray (the unit is usually cm⁻¹), and is related to a tissue type, different tissues having different attenuation coefficients, and x is the path length of the X-ray passing through the medium (e.g., the thickness of the absorbing medium). In CT imaging, an X-ray beam emitted by the X-ray source passes through a patient's body, and different tissues absorb the X-ray differently, resulting in different intensities received by a detector. The X-ray intensity at different positions can be measured so as to reconstruct an image of an internal structure.

FIG. 3 shows a schematic diagram of a CT system during patient examination. As shown in FIG. 3, the CT system 310 generally includes a rotatable gantry 312 and a support table 315, the support table being disposed in a hollow imaging area 314 of the rotatable gantry 312 and configured to carry a patient 330. The rotatable gantry 312 includes an X-ray source S and a detector 318 disposed opposite to the X-ray source S, wherein the detector 318 includes a plurality of independent detector cells D arranged in an array. When the rotatable gantry 312 is located at a certain scanning position, the X-ray source S emits a fan-shaped X-ray beam 320 toward the detector 318, and the plurality of detector cells D separately sense X-rays attenuated by the patient 330, so that a set of projection data is obtained by the detector cells D through sensing, thereby obtaining a corresponding frame of projection data. As the rotatable gantry 312 rotates, the X-ray source S and the detector 318 rotate around a center of rotation O. The CT system 310 performs multiple scans, and during each scan, all the detector cells D may obtain each corresponding frame of projection data through sensing. Under normal operation of the detector cells D, each corresponding frame of projection data can be directly used to reconstruct one or more images. A direction of the detector 318 in which a subject under examination moves toward or out of a medical imaging system is referred to as a row direction, that is, a direction in which the subject under examination on the support table 315 moves toward or out of the rotatable gantry 312. An extension direction of the detector 318 arranged to partially surround the subject under examination, which is perpendicular to the row direction is referred to as a channel direction, that is, a direction in which the detector 318 is arranged in an arc shape along the rotatable gantry 312. The angle at which the detector 318 acquires raw projection data at each of different positions around the subject under examination is referred to as a viewing angle direction, that is, the different angles at which the detector 318 rotates around the subject under examination along the rotatable gantry 312.

To obtain reconstructed images with higher resolution, a new technique has emerged in recent years, wherein the imaging process is improved by means of artificial intelligence. At present, the main improvement methods focus on the image domain, which use a high-resolution image as a ground truth, down-sample a high-resolution image to generate a low-resolution image, and then use deep learning techniques to obtain a high-resolution image based on the low-resolution image. However, resolution improvement by such resolution improvement methods is limited.

In view of the above, the implementations of the present disclosure innovatively propose a medical image processing method that utilizes a neural network model to improve resolution in both the projection domain and the image domain.

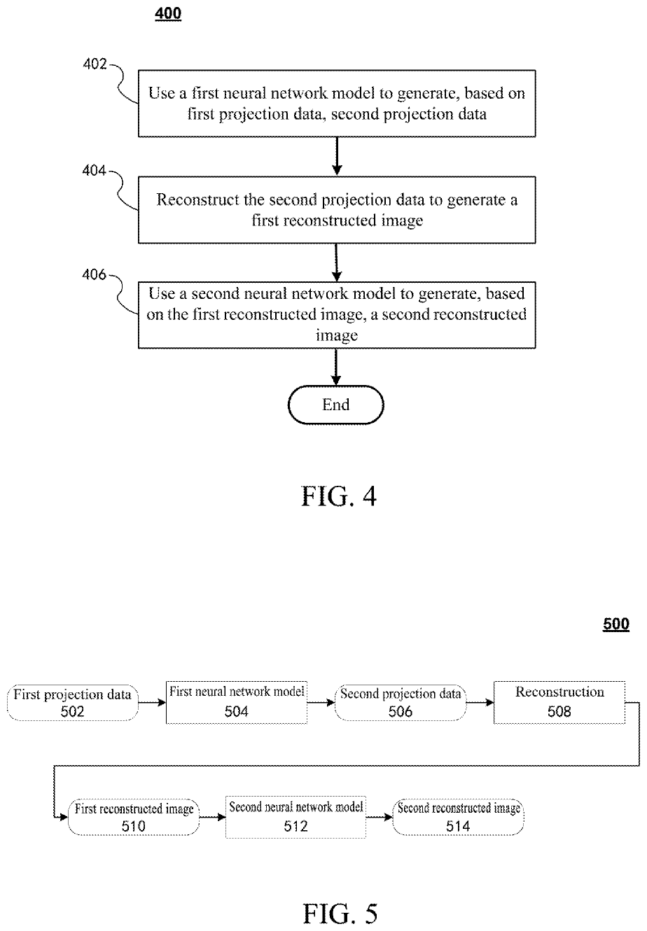

FIG. 4 shows a flowchart of a medical image processing method 400 according to an exemplary embodiment of the present disclosure. In step 402, a first neural network model is used to generate, based on first projection data, second projection data, wherein the second projection data has a higher resolution than the first projection data, and the first neural network is trained on high-resolution projection data and low-resolution projection data generated by a virtual medical imaging system. Next, in step 404, the second projection data is reconstructed to generate a first reconstructed image. Then, in step 406, a second neural network model is used to generate, based on the first reconstructed image, a second reconstructed image, wherein the second reconstructed image has a higher resolution than the first reconstructed image.

By using the first neural network model in the projection domain to improve the resolution of the projection data, and using the second neural network model in the image domain to improve the resolution of the reconstructed image, multi-directional resolution improvement of a CT image can be achieved.

FIG. 5 shows a schematic diagram of a medical image processing process 500 according to an exemplary embodiment of the present disclosure.

First, a first neural network model 504 generates, based on first projection data 502, second projection data 506. In some embodiments, the first projection data may include raw projection data.

FIG. 6 shows a schematic diagram of raw projection data according to an exemplary embodiment of the present disclosure. The raw projection data is three-dimensional projection data acquired by scanning a subject under examination by a detector of a medical imaging system. For example, the raw projection data is acquired by the detector 108 or 318 of the CT system 100, 200, or 310 described in FIG. 1 to FIG. 3. In some embodiments, the medical imaging system may be a computed tomography (CT) medical imaging system, a positron emission tomography-computed tomography (PET-CT) medical imaging system, or a positron emission tomography (PET) medical imaging system. The raw projection data includes three dimensions: a row direction (Z direction), a channel direction (X direction), and a viewing angle direction (Y direction). The row direction (Z direction) indicates a direction of the detector in which the subject under examination moves toward or out of the medical imaging system, i.e., a scanning longitudinal translation direction of the medical imaging system. For example, the detector 108 or 318 of the CT system 100, 200, or 310 may be configured with different numbers of rows of detector cells in the row direction (Z direction), for example, may include 8 rows, 16 rows, 32 rows, 64 rows, 256 rows, 512 rows, and the like. The channel direction (X direction) indicates an extension direction of the detector arranged to partially surround the subject under examination, which is perpendicular to the row direction, i.e., a width direction of the detector 108 or 318 of the medical imaging system. For example, there may be about 900 channels. The viewing angle direction (Y direction) indicates an angle at which the detector acquires raw projection data at each of different positions around the subject under examination, for example, the angle or viewing angle at which the detector 108 or 318 rotates along with the gantry when the CT system 100, 200, or 310 described in the FIG. 1 to FIG. 3 acquires a view. For example, in an axial scan, the medical imaging system may acquire raw projection data or views at about 1000 angular positions, one angular position being referred to as one viewing angle.

In some embodiments, the first projection data may further include filtered projection data, wherein the filtered projection data is obtained by filtering the raw projection data by a kernel function. The kernel function or convolution kernel may affect the sharpness and noise level of the image by adjusting the frequency content of the projection data.

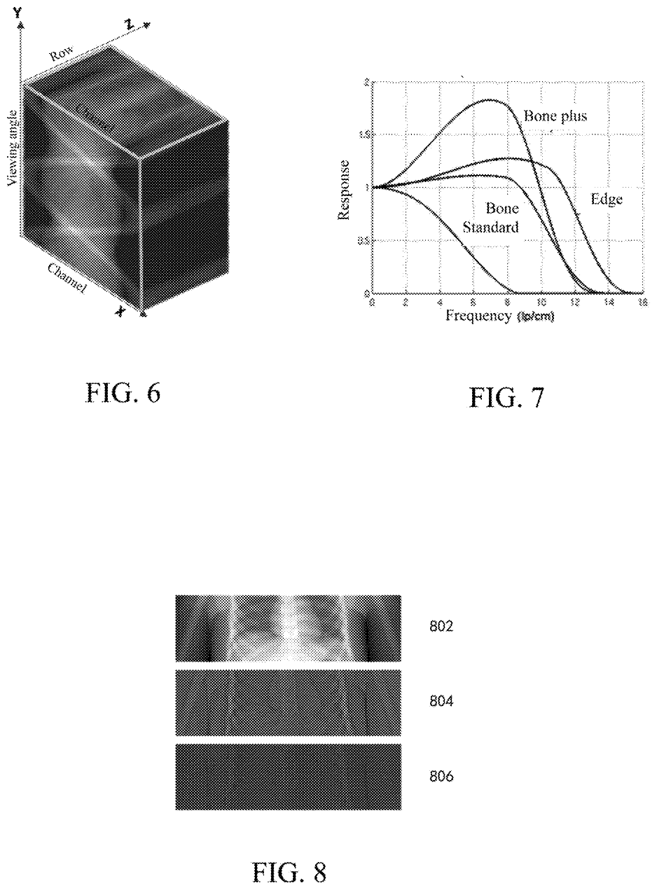

In some embodiments, the kernel function may include one or more of: a standard kernel function, a bone kernel function, a bone plus kernel function, and an edge kernel function. Different types of kernel functions may be used for different anatomical structures. FIG. 7 shows a schematic diagram of frequency response curves of different kernel functions according to an exemplary embodiment of the present disclosure, where the different kernel functions have different enhancement/suppression effects on different frequency components. For example, a standard kernel function can provide a moderate level of sharpness, and provide a good balance in imaging of both soft tissue and bone tissue; a bone kernel function can improve a spatial resolution of a bone; a bone plus kernel function can further enhance sharpness and can display a fine structure of a bone more clearly, which is particularly suitable for an examination that requires a high resolution; an edge kernel function can enhance a display effect for edges, and improve the sharpness and clarity; and a soft tissue kernel function can be suitable for soft tissue imaging. In a tomographic image acquired by the medical imaging system, different soft tissues and high-frequency tissues usually simultaneously exist, for example, lungs and vertebra, heart and vertebra, liver and vertebra, brain soft tissue and skull, etc. Different tissues correspond to different kernel functions, and different kernel functions have different cut-off frequencies and enhancement functions. By filtering projection data with different kernel functions to obtain projection data enhanced at different frequencies, different frequency information of different organs or tissues can be seen more clearly.

FIG. 8 shows a schematic diagram of first projection data according to an exemplary embodiment of the present disclosure. The first projection data may include two-dimensional projection data 802 of the raw projection data in the viewing angle direction, first filtered projection data 804 obtained by filtering the two-dimensional projection data 802 of the raw projection data in the viewing angle direction by a standard kernel function, and second filtered projection data 806 obtained by filtering the two-dimensional projection data 802 of the raw projection data in the viewing angle direction by a bone kernel function. It should be understood that although the first projection data shown in FIG. 8 includes three types of projection data, the components of the first projection data are not limited to such projection data. For example, the first projection data may include only the two-dimensional projection data 802. For another example, the first projection data may include the two-dimensional projection data 802 and one of the first filtered projection data 804 and the second filtered projection data 806. In addition, the first projection data may further include filtered projection data obtained by filtering the two-dimensional projection data 802 of the raw projection data in the viewing angle direction by a bone plus kernel function and/or an edge kernel function.

The first projection data may be provided as an input feature to the first neural network model. For example, when the first projection data includes the two-dimensional projection data 802, the first filtered projection data 804, and the second filtered projection data 806, the two-dimensional projection data 802, the first filtered projection data 804, and the second filtered projection data 806 are provided as three different input channels of input features to the first neural network model, and the first neural network model generates the second projection data based on the input features.

Due to the fact that the raw projection data includes a plurality of viewing angles and the first neural network model processes only two-dimensional projection data of the raw projection data for one viewing angle at a time, the two-dimensional projection data of the raw projection data for different viewing angles is sequentially provided to the first neural network model. For example, at first, first two-dimensional projection data of the raw projection data for a first viewing angle is provided to the first neural network model, then second two-dimensional projection data of the raw projection data for a second viewing angle is provided to the first neural network model, and so on, until last two-dimensional projection data of the raw projection data for a last viewing angle is provided to the first neural network model, where the two-dimensional projection data for the first viewing angle to the last viewing angle are arranged in the order of the viewing angle direction. Accordingly, when the first two-dimensional projection data is provided to the first neural network model, filtered projection data obtained by filtering the first two-dimensional projection data by a kernel function, together with the first two-dimensional projection data, may form different input channels of the input features and be provided to the first neural network model. When the second two-dimensional projection data is provided to the first neural network model, filtered projection data obtained by filtering the second two-dimensional projection data by a kernel function, together with the second two-dimensional projection data, may form different input channels of the input features and be provided to the first neural network model. As such, when the last two-dimensional projection data is provided to the first neural network model, filtered projection data obtained by filtering the last two-dimensional projection data by a kernel function, together with the last two-dimensional projection data, may form different input channels of the input features and be provided to the first neural network model.

By providing both the raw projection data and the filtered projection data to the neural network model, the neural network model has more learnable information, thereby further improving the resolution of output projection data.

In some embodiments, the first neural network model may be configured to perform up-sampling in the channel direction on two-dimensional projection data of the first projection data in the viewing angle direction, so that the second projection data has a higher resolution than the first projection data in a row-channel plane.

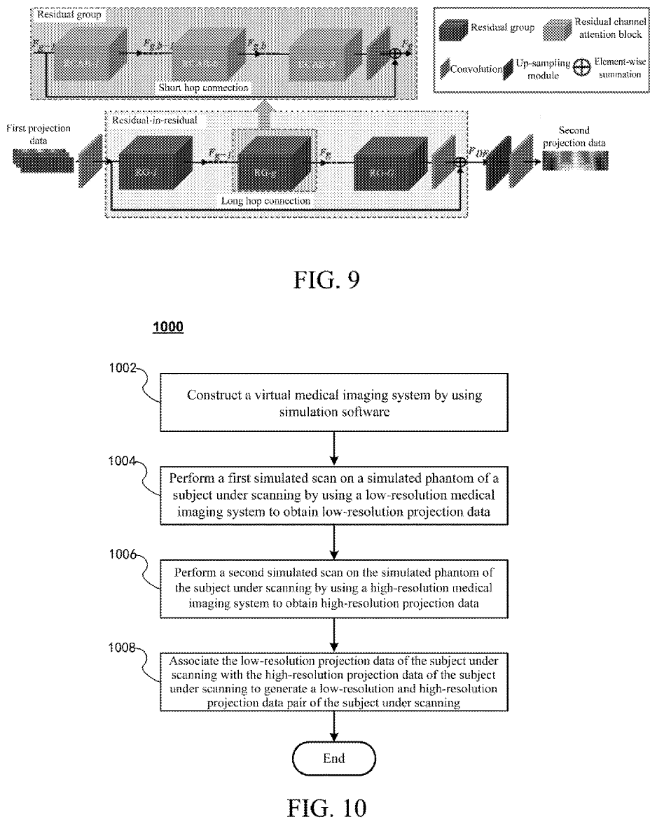

In some embodiments, the first neural network model may use a residual channel attention network (RCAN). FIG. 9 shows a schematic diagram of a first neural network model according to an exemplary embodiment of the present disclosure. The first neural network model generates, based on the first projection data, second projection data. A “residual-in-residual” structure in the RCAN allows the RCAN to capture high-frequency details in the projection data. Although only RCAN is shown here as an example of the first neural network model, it should be understood that the first neural network model may use any suitable neural network model, such as a convolutional neural network, and is not limited to the model shown.

To train the first neural network model, training may be performed by using high-resolution projection data and low-resolution projection data generated by the virtual medical imaging system as a ground truth and an input, respectively.

FIG. 10 shows a flowchart of a method for generating low-resolution projection data and high-resolution projection data 1000 according to an exemplary embodiment of the present disclosure.

In step 1002, the virtual medical imaging system is constructed by using simulation software, the virtual medical imaging system including a low-resolution medical imaging system and a high-resolution medical imaging system.

A first medical imaging system may be constructed by using the simulation software, and the first medical imaging system can generate a medical image having a first resolution. A second medical imaging system may be constructed by using the same or different simulation software, and the second medical imaging system can generate a medical image having a second resolution. The first resolution may be different from the second resolution. The simulation software simulates components, working processes, and imaging results of medical imaging devices (such as CT, MRI, and DR) via a computer. For example, for CT imaging, the simulation software may simulate all components in a CT imaging system, including X-ray generation, beam shaping and filtering, a subject under scanning, an interaction between X-rays and the subject under scanning, a detection process, and image reconstruction.

In some embodiments, the low-resolution medical imaging system and the high-resolution medical imaging system have the same geometry or parameters, such as the relative position of a ray source, a subject under examination, and a detector, except that the low-resolution medical imaging system may have at least one of a larger focal spot size (tube focal spot), a larger detector cell size, and a smaller number of views per rotation than the high-resolution medical imaging system.

In step 1004, a first simulated scan is performed on a simulated phantom of a subject under scanning by using the low-resolution medical imaging system to obtain low-resolution projection data.

The subject under scanning may be characterized by a voxelized phantom having a small-sized structure of interest as the simulated phantom of the subject under scanning. In some embodiments, the simulated phantom may be used to simulate a real human body or a human body part. The voxelized phantom is a discrete 3-D representation of an object. For example, for CT imaging, each voxel may be assigned a material-specific ray attenuation coefficient (i.e., μ value), so that the CT imaging system can calculate the interaction of each voxel with X-rays. As an example, the subject under scanning may include at least one of a temporal bone, a head, and limbs.

The first simulated scan may be performed on the simulated phantom serving as the subject under scanning by using a low-resolution imaging system. The first simulated scan generates low-resolution data that simulates imaging data that an actual low-resolution imaging system may generate.

In step 1006, a second simulated scan is performed on the simulated phantom of the subject under scanning by using the high-resolution medical imaging system to obtain high-resolution projection data.

The second simulated scan may be performed on the same subject under scanning or simulated phantom as in step 1004 by using the high-resolution imaging system. The second simulated scan generates high-resolution data that simulates imaging data that an actual high-resolution imaging system may generate.

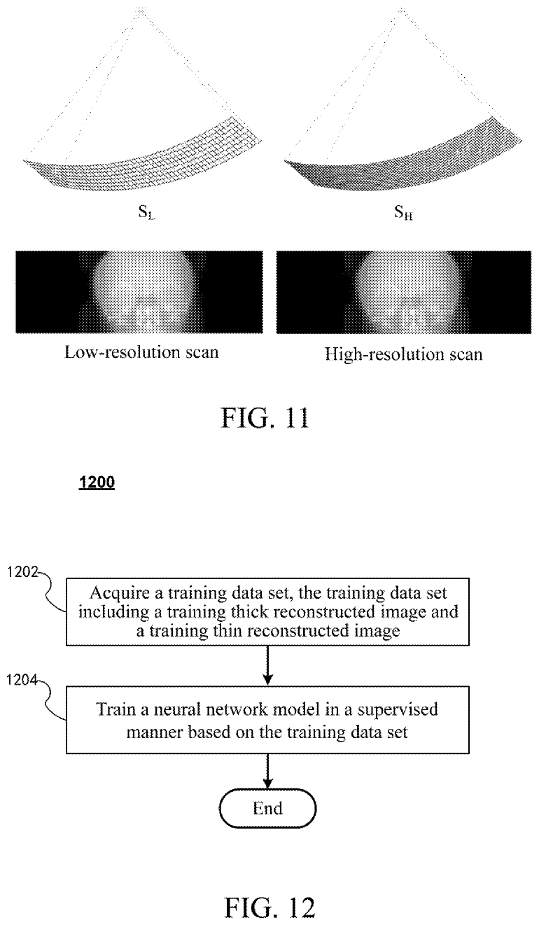

FIG. 11 shows a schematic diagram of a low-resolution medical imaging system setting and a high-resolution medical imaging system setting and imaging thereof according to an exemplary embodiment of the present disclosure. In this example, the low-resolution medical imaging system and the high-resolution medical imaging system have the same overall detector apparent size but different detector cell or pixel sizes, and the detector cell size of the low-resolution medical imaging system setting SL is relatively large for generating low-resolution scan data. The detector cell size of the high-resolution medical imaging system setting SH is relatively small for generating high-resolution scan data. For example, the detector cell size of the low-resolution medical imaging system setting SL has a first size, and the detector cell size of the high-resolution medical imaging system setting SH has a second size, the first size larger than the second size. The first size and the second size may include the side length, the circumference, or the area of a detector cell or pixel. Accordingly, the density of detector cells of the low-resolution medical imaging system setting SL is smaller than the density of detector cells of the high-resolution medical imaging system setting SH when the two settings have the same overall detector apparent size.

In step 1008, the low-resolution projection data of the subject under scanning is associated with the high-resolution projection data of the subject under scanning to generate a low-resolution and high-resolution projection data pair of the subject under scanning.

The low-resolution projection data and the high-resolution projection data respectively obtained in step 1004 and step 1006 are associated with each other. This association is based on the same subject under scanning, meaning that each pair of data is obtained from the same phantom or image region, but represents imaging results of different resolutions, separately. In other words, the associated low-resolution projection data and high-resolution projection data may have a registration relationship therebetween without transformation.

The method for generating a low-resolution and high-resolution projection data pair according to an exemplary embodiment of the present disclosure is described above. By using the method, a large number of low-resolution and high-resolution projection data pairs can be generated without actually performing a plurality of physical scans. By training a neural network model by using these projection data pairs, neural network-based image resolution improvement can be implemented.

In some embodiments, an L1 loss function (absolute value loss function) may be used to evaluate fidelity between the high-resolution projection data as the ground truth and a predicted result generated by the first neural network model based on the low-resolution projection data.

Referring back to FIG. 5, after the first neural network model 504 generates the second projection data 506 based on the first projection data 502, the second projection data 506 may be reconstructed 508 to generate the first reconstructed image 510.

In some embodiments, the image of the target volume of the subject may be reconstructed by using an iterative or analytical image reconstruction method. For example, the image of the target volume of the subject may be reconstructed by using an analytical image reconstruction method such as filtered back projection (FBP). As another example, iterative image reconstruction methods (such as advanced statistical iterative reconstruction (ASIR), conjugate gradient (CG), maximum likelihood expectation maximization (MLEM), model-based iterative reconstruction (MBIR), etc.) may be used to reconstruct images of a target volume of the subject.

Due to the fact that the first neural network model 504 has performed resolution improvement on the first projection data in the channel direction, the reconstruction parameter may be adjusted during a reconstruction process, thereby ensuring the quality of a reconstructed image. In some embodiments, reconstructing the second projection data may include adjusting a reconstruction parameter according to a resolution increase multiple of the second projection data compared with the first projection data. The adjusting the reconstruction parameter may include scaling the reconstruction parameter in the channel direction according to the resolution increase multiple. In some embodiments, the reconstruction parameter in the channel direction may include: the number of channel detector cells, sizes of the channel detector cells, and angles of the channel detector cells. For example, when a size of a detector cell in the channel direction of the second projection data is reduced, compared with the first projection data, to ¼ of a size of the detector cell in the channel direction of the first projection data, among the reconstruction parameters, a size of the detector cell in the channel direction may be adjusted to 0.25 times the raw size, the number of detector cells in the channel direction may be adjusted to 4 times the raw number, and an angle of the detector cell in the channel direction may be adjusted to 0.25 times the raw angle, as shown in Table 1.

TABLE 1
Reconstruction parameter adjustment

| Geometry system parameter | Adjustment |
|---|---|
| Number of detector cells in channel direction | Raw number × 4 |
| Size of detector cells in channel direction | Raw size × 0.25 |
| Angle of detector cells in channel direction | Raw angle × 0.25 |

Further, due to a change in the sizes of the detector cells in the channel direction, the adjusting the reconstruction parameter may include re-determining a position of a central detector cell.

Further, the adjusting the reconstruction parameter may include adjusting a cut-off frequency and a filter window width of the kernel function in the reconstruction process. For example, when the FBP method is used for image reconstruction, the cut-off frequency and the filter window width of the kernel function used in the filtering process may be adjusted.

By adjusting the reconstruction parameter to correspond to the projection data with improved resolution, the image quality of the reconstructed image can be ensured, and the axial resolution of the image can be improved.

After the first reconstructed image 510 is generated, the second neural network model 512 may generate, based on the first reconstructed image 510, a second reconstructed image 514.

In some embodiments, the second neural network model is configured to perform up-sampling in the row direction on the first reconstructed image, so that the second reconstructed image has a higher resolution than the first reconstructed image in the row direction.

The resolution of the CT image in the row direction is mainly affected by the slice thickness of the image (i.e., the thickness of the tomographic reconstructed image). For the same CT volume data with the same number of images, a thin reconstructed image has a higher resolution in the row direction than a thick reconstructed image, wherein the thin reconstructed image (also referred to as a thin slice thickness reconstructed image tomography or a thin tomographic image) has a thinner slice thickness than the thick reconstructed image, and conversely, the thick reconstructed image (also referred to as a thick slice thickness reconstructed image tomography or a thick tomographic image) has a thicker slice thickness than the thin reconstructed image. Therefore, the neural network model may be trained by using the thick reconstructed image and the thin reconstructed image as the input and the ground truth of the neural network model, respectively, to improve the resolution of the reconstructed image in the row direction.

FIG. 12 shows a flowchart of a method for training a neural network model 1200 according to an exemplary embodiment of the present disclosure.

In step 1202, a training data set is acquired, the training data set including a training thick reconstructed image and a training thin reconstructed image, wherein the training thick reconstructed image (also referred to as a training thick slice thickness reconstructed image tomography or a training thick tomographic image) has a thicker slice thickness than the training thin reconstructed image, and conversely, the training thin reconstructed image (also referred to as a training thin slice thickness reconstructed image tomography or a training thin tomographic image) has a thinner slice thickness than the training thick reconstructed image. The training thick reconstructed image and the training thin reconstructed image are obtained by splitting a training raw reconstructed image. The training thin reconstructed image has a higher resolution than the training thick reconstructed image, and the training thin reconstructed image is used as a ground truth for an output of the neural network model.

In some embodiments, the training raw reconstructed image may be a reconstructed image obtained by performing reconstruction based on three-dimensional projection data. The three-dimensional projection data is acquired by scanning a subject under examination by a detector of a medical imaging system. The three-dimensional projection data includes three dimensions: a row direction, a channel direction, and a viewing angle direction, the row direction indicates a direction of the detector in which the subject under examination moves toward or out of the medical imaging system, the channel direction indicates an extension direction of the detector arranged to partially surround the subject under examination, which is perpendicular to the row direction, and the viewing angle direction indicates an angle at which the detector acquires the three-dimensional projection data at each of different positions around the subject under examination.

In step 1204, the neural network model may be trained in a supervised manner based on the training data set. In some embodiments, the neural network model may include any supervised learning-based neural network model, for example, a convolutional neural network.

In some embodiments, training the neural network model in a supervised manner based on the training data set includes: using the neural network model to generate, based on the training thick reconstructed image, a predicted result of an enhanced reconstructed image having a higher resolution than the training thick reconstructed image; calculating a loss function between the predicted result and the ground truth; and updating parameters of the neural network model based on the loss function to obtain a trained neural network model.

In some embodiments, a weight of the loss function in the row direction may be greater than weights of the loss function in the channel direction and the viewing angle direction. For example, the loss function may be a combination of a mean absolute error loss function, a gradient loss function, a mean structural similarity index metric loss function, and a perceptual loss function, wherein the weight ratio in the row direction, the channel direction, and the viewing angle direction is 2:1:1.

In some embodiments, the second neural network model may be trained by using the method 1200.

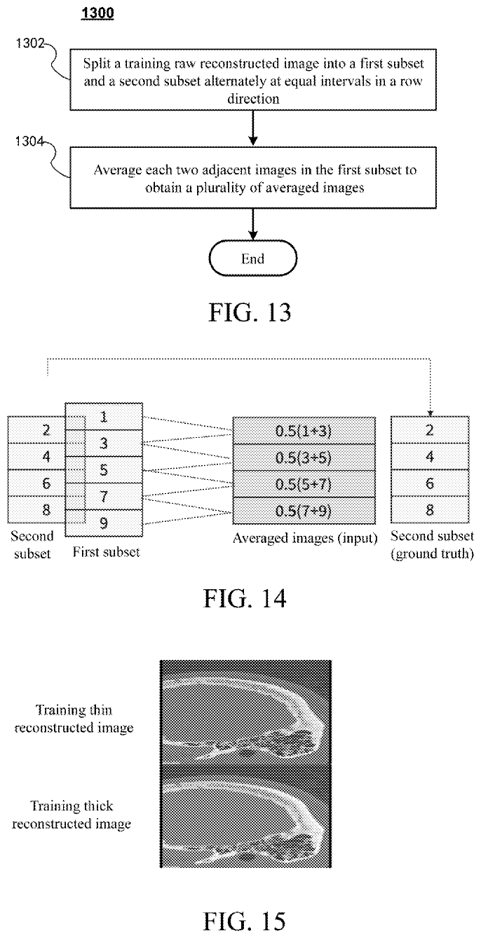

FIG. 13 shows a flowchart of a method for generating a training thick reconstructed image and a training thin reconstructed image 1300 according to an exemplary embodiment of the present disclosure.

In step 1302, a training raw reconstructed image is split into a first subset and a second subset alternately at equal intervals in a row direction. The training raw reconstructed image may be a real CT reconstructed image having a high resolution obtained by an imaging system.

In step 1304, each two adjacent images in the first subset are averaged to obtain a plurality of averaged images. The plurality of averaged images are combined to be used as the training thick reconstructed image, and images in the second subset are combined to be used as the training thin reconstructed image. The training thin reconstructed image has a higher resolution than the training thick reconstructed image in the row direction.

FIG. 14 shows a schematic diagram of a process for generating a training thick reconstructed image and a training thin reconstructed image according to an exemplary embodiment of the present disclosure.

First, the training raw image is split into a first subset and a second subset alternately at equal intervals in the row direction. For example, the first subset includes two-dimensional slice images numbered 1, 3, 5, 7, 9, etc., and the second subset includes two-dimensional slice images numbered 2, 4, 6, 8, etc. Then, each two adjacent two-dimensional slice images in the first subset are averaged to obtain a plurality of averaged images. For example, the two-dimensional slice images numbered 1 and 3 are averaged to obtain a first averaged image, and the center position of the first averaged image is the same as that of the two-dimensional slice image numbered 2. Due to the fact that information contained in the two two-dimensional slice images is averaged, the obtained first averaged image is blurred compared with the two-dimensional slice image numbered 2, that is, the slice thickness in the row direction of the first averaged image is thicker, and the slice thickness in the row direction of the two-dimensional slice image numbered 2 is thinner. Similarly, the two-dimensional slice images numbered 3 and 5 are averaged to obtain a second averaged image, and the center position of the second averaged image is the same as that of the two-dimensional slice image numbered 4; the two-dimensional slice images numbered 5 and 7 are averaged to obtain a third averaged image, and the center position of the third averaged image is the same as that of the two-dimensional slice image numbered 6; and the two-dimensional slice images numbered 7 and 9 are averaged to obtain a fourth averaged image, and the center position of the fourth averaged image is the same as that of the two-dimensional slice image numbered 8, and so on. Finally, due to the fact that the slice thickness of the plurality of averaged images, i.e., the first averaged image, the second averaged image, the third averaged image, the fourth averaged image, etc., is thicker, the plurality of averaged images are combined to be used as the training thick reconstructed image, i.e., the input to the neural network model. Due to the fact that the slice thickness of the second subset, i.e., the two-dimensional slice images numbered 2, 4, 6, 8, etc., is thinner, the images in the second subset are combined to be used as the training thin reconstructed image, i.e., the ground truth.

FIG. 15 shows a schematic diagram of a training thick reconstructed image and a training thin reconstructed image according to an exemplary embodiment of the present disclosure.

Therefore, by splitting a training raw image to generate a training thick reconstructed image and a training thin reconstructed image, the generation efficiency of image pairs can be improved while ensuring the image quality.

In addition, the present disclosure further provides a medical imaging system, including: a scanning device, configured to acquire projection data of a subject under examination; and a processor, configured to perform any one of the methods 400, 1000, 1200, and 1300.

In addition, the present disclosure further provides a non-transient computer-readable medium having instructions stored thereon, wherein the instructions are executable by a processor to implement any one of the methods 400, 1000, 1200, and 1300.

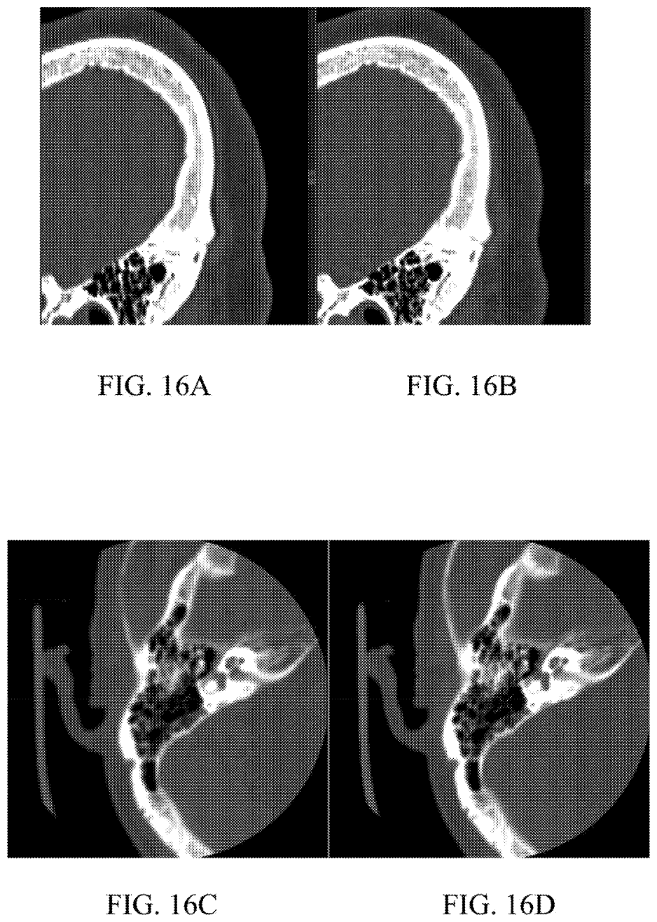

FIG. 16A and FIG. 16C show reconstructed images generated directly from the raw projection data, and FIG. 16B and FIG. 16D show reconstructed images generated from raw projection data by using the method of the present disclosure. It can be seen from the comparison between FIG. 16A and FIG. 16B that the reconstructed images generated by using the method of the present disclosure have a higher resolution in a row direction. It can be seen from the comparison between FIG. 16C and FIG. 16D that the reconstructed images generated by using the method of the present disclosure have a higher resolution in a row-channel plane.

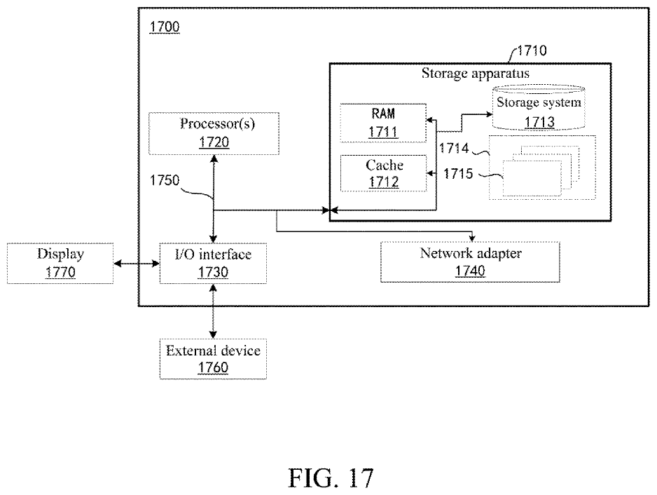

FIG. 17 shows an exemplary block diagram of a computing device 1700 according to an exemplary embodiment of the present disclosure. The computing device 1700 may be implemented as an example of the computing device 216 shown in FIG. 2. The computing device 1700 includes: one or more processors 1720; and a storage apparatus 1710, configured to store one or more programs, wherein the one or more programs, when executed by the one or more processors 1720, cause the one or more processors 1720 to implement the processes described in the present disclosure. The processor is, for example, a digital signal processor (DSP), a microcontroller, an application-specific integrated circuit (ASIC), or a microprocessor.

The computing device 1700 shown in FIG. 17 is merely an example, and should not impose any limitation on the functions and use scope of the embodiments of the present disclosure.

As shown in FIG. 17, the computing device 1700 is represented in the form of a general-purpose computing device. Components of the computing device 1700 may include, but are not limited to: one or more processors 1720, a storage apparatus 1710, and a bus 1750 connecting different system components (including the storage apparatus 1710 and the processor 1720).

The bus 1750 represents one or more of several types of bus structures, including a memory bus or a memory controller, a peripheral bus, an accelerated graphics port, a processor, or a local bus using any of a plurality of bus structures. For example, these architectures include, but are not limited to, an Industrial Standard Architecture (ISA) bus, a Micro Channel Architecture (MAC) bus, an enhanced ISA bus, a Video Electronics Standards Association (VESA) local bus, and a Peripheral Component Interconnect (PCI) bus.

The computing device 1700 typically includes a plurality of computer system-readable media. These media may be any available media that can be accessed by the computing device 1700, including volatile and non-volatile media as well as removable and non-removable media.

The storage apparatus 1710 may include a computer system-readable medium in the form of a volatile memory, for example, a random access memory (RAM) 1711 and/or a cache memory 1712. The computing device 1700 may further include other removable/non-removable, and volatile/non-volatile computer system storage media. Only as an example, a storage system 1713 may be configured to read/write a non-removable, non-volatile magnetic medium (not shown in FIG. 17, typically referred to as a “hard disk drive”). Although not shown in FIG. 17, a magnetic disk drive configured to read/write a removable non-volatile magnetic disk (for example, a “floppy disk”) and an optical disc drive configured to read/write a removable non-volatile optical disc (for example, a CD-ROM, a DVD-ROM, or other optical media) may be provided. In these cases, each drive may be connected to the bus 1750 via one or more data medium interfaces. The storage apparatus 1710 may include at least one program product which has a group of program modules (for example, at least one program module) configured to execute the functions of the embodiments of the present disclosure.

A program/utility tool 1714 having a group (at least one) of program modules 1715 may be stored in, for example, the storage apparatus 1710. This program module 1715 includes, but is not limited to, an operating system, one or more applications, other program modules, and program data, and each of these examples or a certain combination thereof may include an implementation of a network environment. The program module 1715 typically executes the function and/or method in any embodiment described in the present disclosure.

The computing device 1700 may also communicate with one or more external devices 1760 (such as a keyboard, a pointing device, and a display 1770), and may also communicate with one or more devices that enable a user to interact with the computing device 1700, and/or communicate with any device (such as a network card and a modem) that enables the computing device 1700 to communicate with one or more other computing devices. Such communication may be carried out via an input/output (I/O) interface 1730. Moreover, the computing device 1700 may also communicate, via a network adapter 1740, with one or more networks (for example, a local area network (LAN), a wide area network (WAN), and/or a public network, for example, the Internet). As shown in FIG. 17, the network adapter 1740 communicates with other modules of the computing device 1700 via the bus 1750. It should be understood that although not shown in the figure, other hardware and/or software modules can be used in combination with the computing device 1700, including, but not limited to: microcode, device drivers, redundant processing units, external disk drive arrays, RAID systems, tape drives, data backup storage systems, and the like.

The processor 1720, by running programs stored in the storage apparatus 1710, implements various functional applications and data processing, such as implementing the processes described in the present disclosure.

The technique described herein may be implemented with hardware, software, firmware, or any combination thereof, unless specifically described as being implemented in a specific manner. Any features described as modules or components may also be implemented together in an integrated logical device, or separately implemented as discrete but interoperable logical devices. If implemented with software, the technique may be implemented at least in part by a non-transitory processor-readable storage medium that includes instructions, wherein when executed, the instructions perform one or more of the aforementioned methods. The non-transitory processor-readable data storage medium may form part of a computer program product that may include an encapsulation material. Program code may be implemented in a high-level procedural programming language or an object-oriented programming language so as to communicate with a processing system. If desired, the program code may also be implemented in an assembly language or a machine language. In fact, the mechanisms described herein are not limited to the scope of any particular programming language. In any case, the language may be a compiled language or an interpreted language.

One or more aspects of at least some embodiments may be implemented by representative instructions that are stored in a machine-readable medium and represent various logic in a processor, wherein when read by a machine, the representative instructions cause the machine to manufacture the logic for executing the technique described herein.

Such machine-readable storage media may include, but are not limited to, a non-transitory tangible arrangement of an article manufactured or formed by a machine or device, including storage media, such as: a hard disk; any other types of disk, including a floppy disk, an optical disk, a compact disk read-only memory (CD-ROM), compact disk rewritable (CD-RW), and a magneto-optical disk; a semiconductor device such as a read-only memory (ROM), a random access memory (RAM) such as a dynamic random access memory (DRAM) and a static random access memory (SRAM), an erasable programmable read-only memory (EPROM), a flash memory, and an electrically erasable programmable read-only memory (EEPROM); a phase change memory (PCM); a magnetic or optical card; or any other type of medium suitable for storing electronic instructions.

Instructions may further be sent or received by means of a network interface device that uses any of a number of transport protocols (for example, Frame Relay, Internet Protocol (IP), Transfer Control Protocol (TCP), User Datagram Protocol (UDP), and Hypertext Transfer Protocol (HTTP)) and through a communication network using a transmission medium.

An example communication network may include a local area network (LAN), a wide area network (WAN), a packet data network (for example, the Internet), a mobile phone network (for example, a cellular network), a plain old telephone service (POTS) network, and a wireless data network (for example, Institute of Electrical and Electronics Engineers (IEEE) 802.11 standards referred to as Wi-Fi®, and IEEE 802.19 standards referred to as WiMax®), IEEE 802.15.4 standards, a peer-to-peer (P2P) network, and the like. In one example, the network interface device may include one or more physical jacks (for example, Ethernet, coaxial, or phone jacks) or one or more antennas for connection to the communication network. In one example, the network interface device may include a plurality of antennas that wirelessly communicate using at least one of single-input multiple-output (SIMO), multiple-input multiple-output (MIMO), and multiple-input single-output (MISO) technology.

The term “transmission medium” should be considered to include any intangible medium capable of storing, encoding, or carrying instructions for execution by a machine, and the “transmission medium” includes digital or analog communication signals or any other intangible medium for facilitating communication of such software.

Thus far, the image processing method and system, the neural network model training method, and the medical imaging system according to the present disclosure have been described, and a computer-readable storage medium capable of implementing the methods has also been described.

Some exemplary embodiments have been described above. However, it should be understood that various modifications can be made to the exemplary embodiments described above without departing from the spirit and scope of the present disclosure. For example, an appropriate result can be achieved if the described techniques are performed in a different order and/or if the components of the described system, architecture, device, or circuit are combined in other manners and/or replaced or supplemented with additional components or equivalents thereof; accordingly, the modified other implementations also fall within the protection scope of the claims.

1. A method for medical image processing, comprising:
using a first neural network model to generate, based on first projection data, second projection data, wherein the second projection data has a higher resolution than the first projection data, and the first neural network model is trained on high-resolution projection data and low-resolution projection data generated by a virtual medical imaging system;
reconstructing the second projection data to generate a first reconstructed image; and
using a second neural network model to generate, based on the first reconstructed image, a second reconstructed image, wherein the second reconstructed image has a higher resolution than the first reconstructed image.

2. The method according to claim 1, wherein the first projection data comprises: raw projection data, wherein the raw projection data is three-dimensional projection data acquired by scanning a subject under examination by a detector of the medical imaging system and the raw projection data comprises three dimensions: a row direction, a channel direction, and a viewing angle direction, the row direction indicates a direction of the detector in which the subject under examination moves toward or out of the medical imaging system, the channel direction indicates an extension direction of the detector arranged to partially surround the subject under examination, which is perpendicular to the row direction, and the viewing angle direction indicates an angle at which the detector acquires the raw projection data at each of different positions around the subject under examination.

3. The method according to claim 2, wherein the first projection data further comprises: filtered projection data, wherein the filtered projection data is obtained by filtering the raw projection data by a kernel function.

4. The method according to claim 3, wherein the kernel function comprises one or more of the following: a standard kernel function, a bone kernel function, a bone plus kernel function, and an edge kernel function.

5. The method according to claim 2, wherein the first neural network model is configured to perform up-sampling in the channel direction on two-dimensional projection data of the first projection data in the viewing angle direction, so that the second projection data has a higher resolution than the first projection data in a row-channel plane.

6. The method according to claim 5, wherein the reconstructing the second projection data comprises: adjusting a reconstruction parameter according to a resolution increase multiple of the second projection data compared with the first projection data.

7. The method according to claim 6, wherein the adjusting a reconstruction parameter according to a resolution increase multiple of the second projection data compared with the first projection data comprises:
scaling the reconstruction parameter in the channel direction according to the resolution increase multiple;
re-determining a position of a central detector cell; and
adjusting a cut-off frequency and a filter window width of the kernel function in a reconstruction process.

8. The method according to claim 7, wherein the reconstruction parameter in the channel direction comprises: the number of channel detector cells, sizes of the channel detector cells, and angles of the channel detector cells.

9. The method according to claim 1, wherein the first neural network model uses a residual channel attention network (RCAN).

10. The method according to claim 1, wherein the high-resolution projection data and the low-resolution projection data are generated through the following steps:
constructing the virtual medical imaging system by using simulation software, the virtual medical imaging system comprising a low-resolution medical imaging system and a high-resolution medical imaging system;
performing a first simulated scan on a simulated phantom of a subject under scanning by using the low-resolution medical imaging system to obtain the low-resolution projection data;
performing a second simulated scan on the simulated phantom of the subject under scanning by using the high-resolution medical imaging system to obtain the high-resolution projection data; and
associating the low-resolution projection data of the subject under scanning with the high-resolution projection data of the subject under scanning to generate a low-resolution and high-resolution projection data pair of the subject under scanning.

11. The method according to claim 2, wherein the second neural network model is configured to perform up-sampling in the row direction on the first reconstructed image, so that the second reconstructed image has a higher resolution than the first reconstructed image in the row direction.

12. A method for training a neural network model, comprising:
acquiring a training data set, the training data set comprising a training thick reconstructed image and a training thin reconstructed image, wherein the training thick reconstructed image and the training thin reconstructed image are obtained by splitting a training raw reconstructed image, the training thin reconstructed image has a higher resolution than the training thick reconstructed image, and the training thin reconstructed image is used as a ground truth of an output of the neural network model; and
training the neural network model in a supervised manner based on the training data set.

13. The method according to claim 12, wherein the training raw reconstructed image is a reconstructed image obtained by performing reconstruction based on three-dimensional projection data, the three-dimensional projection data is acquired by scanning a subject under examination by a detector of a medical imaging system and the three-dimensional projection data comprises three dimensions: a row direction, a channel direction, and a viewing angle direction, the row direction indicates a direction of the detector in which the subject under examination moves toward or out of the medical imaging system, the channel direction indicates an extension direction of the detector arranged to partially surround the subject under examination, which is perpendicular to the row direction, and the viewing angle direction indicates an angle at which the detector acquires the three-dimensional projection data at each of different positions around the subject under examination.

14. The method according to claim 13, wherein the training thick reconstructed image and training thin reconstructed image are obtained through the following steps:
splitting the training raw reconstructed image into a first subset and a second subset alternately at equal intervals in the row direction; and
averaging each two adjacent images in the first subset to obtain a plurality of averaged images, wherein the plurality of averaged images are combined to be used as the training thick reconstructed image, images in the second subset are combined to be used as the training thin reconstructed image, and the training thin reconstructed image has a higher resolution than the training thick reconstructed image in the row direction.

15. The method according to claim 12, wherein the training the neural network model in a supervised manner based on the training data set comprises:
using the neural network model to generate, based on the training thick reconstructed image, a predicted result of an enhanced reconstructed image having a higher resolution than the training thick reconstructed image;
calculating a loss function between the predicted result and the ground truth; and
updating parameters of the neural network model based on the loss function to obtain a trained neural network model.

16. The method according to claim 15, wherein a weight of the loss function in the row direction is greater than weights of the loss function in the channel direction and the viewing angle direction.
